(19) United States
(12) Patent Application Publication
(10) Pub. No.: US 2019/0143733 A1
(43) Pub. Date: May 16, 2019

(54) PAPER BINDING APPARATUS AND PAPER BINDING METHOD

(71) Applicant: TOSHIBA TEC KABUSHIKI KAISHA, Tokyo (JP)

(72) Inventor: Kikuo MIZUTANI, Izu Shizuoka (JP)

(21) Appl. No.: 16/052,849

(22) Filed: Aug. 2, 2018

(30) Foreign Application Priority Data
Nov. 13, 2017 (JP) 2017-218430

(51) Int. Cl. B42C 19/08; B65H 37/04; B42C 9/00; B65H 5/06; B65H 37/02

(52) U.S. Cl. CPC B42C 19/08; B65H 37/04; B65H 37/02; B65H 5/062; B42C 9/0062

(57) ABSTRACT

A paper binding apparatus includes a pair of guides between which a paper bundle connected body formed by applying an adhesive tape to edge portions of sheets that are overlapped in a thickness direction, is moved in a reference direction while pinching the paper bundle connected body in the thickness direction, a guide plate on one side of the paper bundle connected body and downstream of the pair of guides, the guide plate having at least one guide surface that causes the paper bundle connected body guided thereby to be bent, and a driving roller configure to rotate in a first direction to move the paper bundle connected body and to cause a leading edge of the paper bundle connected body to be guided and bent by the at least one guide surface and the edge portions of the sheets to be shifted from each other in the reference direction.

### CROSS-REFERENCE TO RELATED APPLICATION

This application is based upon and claims the benefit of priority from Japanese Patent Application No. 2017-218430, filed Nov. 13, 2017, the entire contents of which are incorporated herein by reference.

### FIELD

Embodiments described herein relate generally to a paper binding apparatus and a paper binding method.

### BACKGROUND

In the related art, a paper binding apparatus applies an adhesive tape to an edge portion of a plurality of sheets of paper so that the plurality of sheets of paper can be bound together.

When this paper binding apparatus is used, the user prepares a state where a plurality of sheets of paper is shifted in a stepwise manner in a reference direction orthogonal to a direction in which the edge portion of the paper extends along the main surface of the paper. Then, the adhesive tape is applied to the edge portions of the plurality of sheets of paper by the paper binding apparatus. This makes it possible to increase the area where the adhesive tape is applied to each paper and improves the reliability of the adhesive tape sticking to each paper.

However, when the adhesive tape is applied to a plurality of sheets of paper as described above, as the number of paper increases, the total length of a plurality of sheets of paper to be shifted in the reference direction becomes longer.

### DESCRIPTION OF THE DRAWINGS

FIG. 1 is a side view illustrating a main portion of a paper bundle to be bound by a paper binding apparatus according to an embodiment.

FIG. 2 is a partially cutaway side view illustrating the paper binding apparatus according to the embodiment.

FIG. 3 is a plan view illustrating the paper binding apparatus according to the embodiment.

FIG. 4 is a sectional view illustrating a sticking unit of the paper binding apparatus according to the embodiment as seen from the side.

FIG. 5 is a perspective view illustrating the sticking unit of the paper binding apparatus according to the embodiment as seen from the front.

FIG. 6 is a perspective view illustrating the paper binding apparatus according to the embodiment as viewed from the rear.

FIG. 7 is a front view illustrating a link mechanism in the paper binding apparatus according to the embodiment.

FIG. 8 is a side view illustrating a first guide plate and a tape base in the paper binding apparatus according to the embodiment.

FIG. 9 is a view for explaining movement, bending and pressing steps in the paper binding method according to the embodiment.

FIG. 10 is a view for explaining a returning process in the paper binding method according to the embodiment.

### DETAILED DESCRIPTION

Embodiments provide a paper binding apparatus and a paper binding method that can reliably apply an adhesive tape to a plurality of sheets of paper while suppressing the total length of the plurality of paper sheets in a reference direction.

In general, according to one embodiment, a paper binding apparatus according to the embodiment includes a pair of guides between which a paper bundle connected body that is formed by applying an adhesive tape to edge portions of a plurality of sheets that are overlapped in a thickness direction, is moved in a reference direction that is along a main surface of the plurality of sheets while pinching the paper bundle connected body in the thickness direction, a guide plate positioned on one side of the paper bundle connected body and downstream of the pair of guides in a forward movement direction of the paper bundle connected body, the guide plate having at least one guide surface that causes the paper bundle connected body guided by the at least one guide surface to be bent, and a driving roller configure to rotate in a first direction to move the paper bundle connected body in the forward movement direction and to cause a leading edge of the paper bundle connected body to be guided and bent by the at least one guide surface and the edge portions of the plurality of sheets to be shifted from each other in the reference direction.

Hereinafter, a paper binding apparatus and a paper binding method according to an embodiment will be described with reference to the drawings.

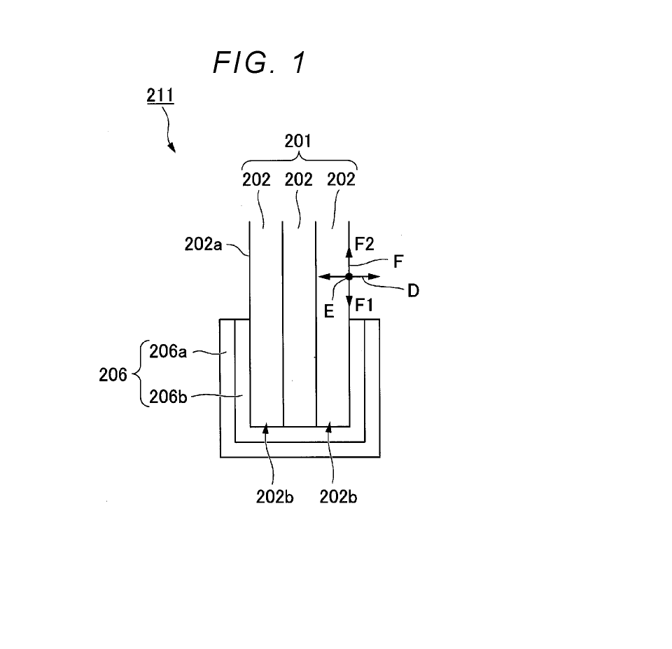

The paper binding apparatus of the present embodiment is an apparatus for reliably applying an adhesive tape 206 to a paper bundle 201 illustrated in FIG. 1. The paper bundle 201 is configured so that a plurality of sheets of paper 202 are overlapped in a thickness direction D of a plurality of sheets of paper 202. Here, a reference direction F orthogonal to an extending direction E in which the edge portions 202b of the plurality of sheets of paper 202 extend is defined along a main surface 202a of the plurality of sheets of paper 202. Each paper 202 has a rectangular shape having an edge portion (e.g., edge portion 202b or the like) extending in the extending direction E and an edge portion extending in the reference direction F when viewed in the thickness direction D, for example.

In the paper bundle 201, the positions in the reference direction F of the edge portions 202b of the plurality of sheets of paper 202 are aligned with each other. Hereinafter, a state where a plurality of sheets of paper 202 are obtained in this way is referred to as an aligned state of the paper bundle 201.

In the adhesive tape 206, a non-adhesive base material layer 206a and a sticky adhesive layer 206b are laminated. The material, the thickness, and the like of the base material layer 206a and the adhesive layer 206b are not particularly limited to any type.

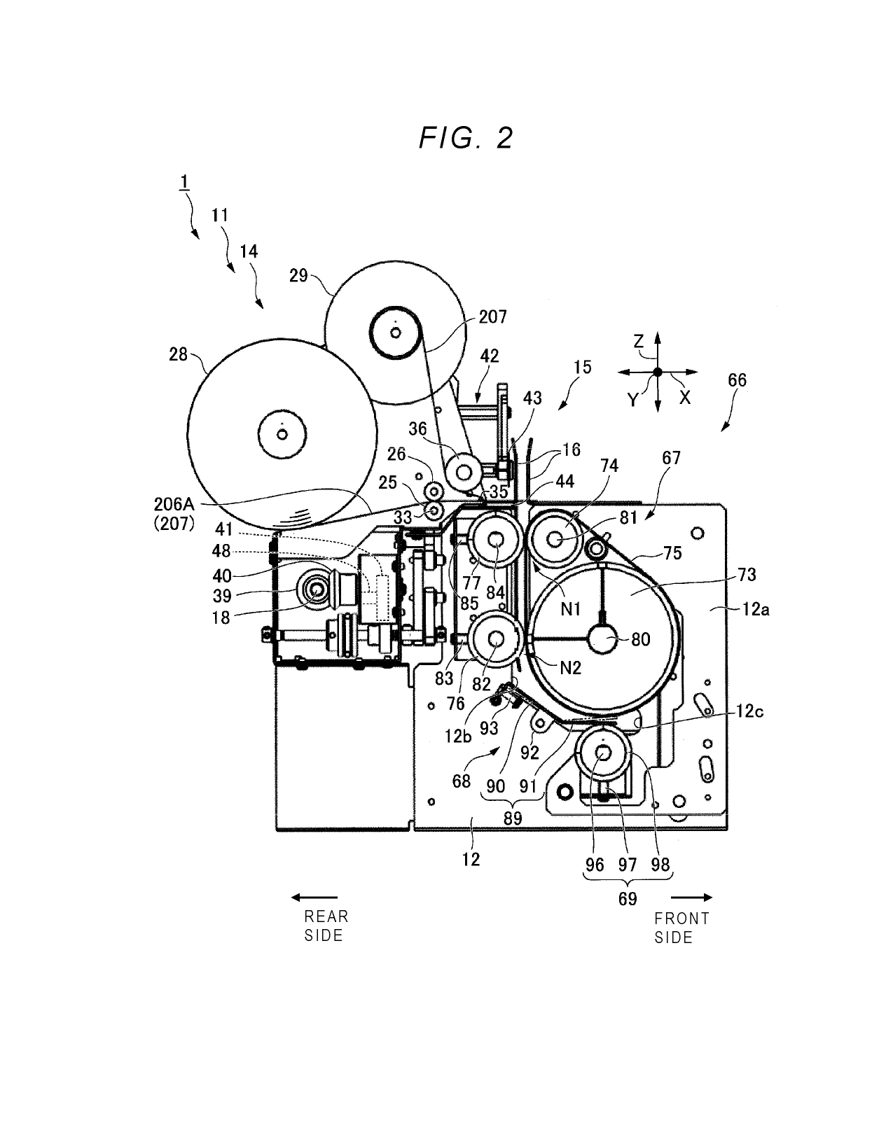

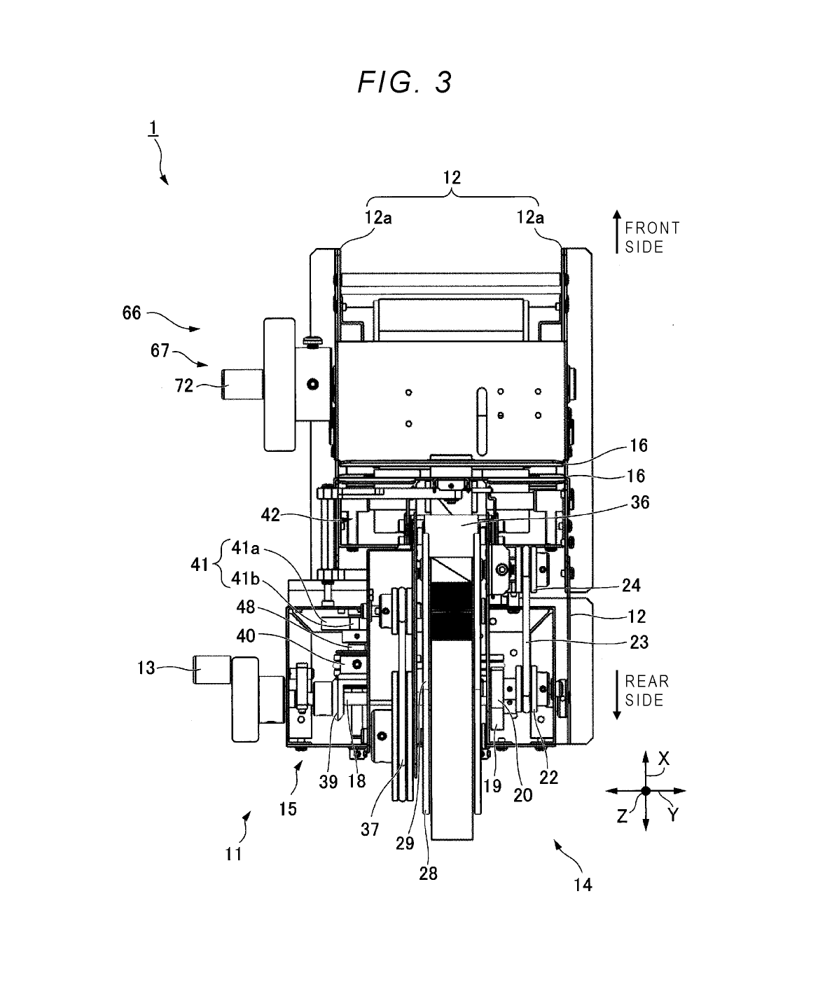

As illustrated in FIG. 2 and FIG. 3, the paper binding apparatus 1 of the present embodiment includes a sticking unit 11 and a sticking reinforcing unit 66.

Hereinafter, front and rear direction X which is a direction in which the sticking unit 11 and the sticking reinforcing unit 66 are arranged along the horizontal plane will be described. In the front and rear direction X, the direction of the sticking reinforcing unit 66 with respect to the sticking unit 11 is referred to as forward, and the opposite direction thereto is referred to as rearward. Further, along the horizontal plane, left and right direction Y, which is orthogonal to the front and rear direction X, and up and down direction Z are defined.

The sticking unit 11 has a frame 12, a first handle 13, a tape feeding unit 14, a tape cutting unit 15, and a pair of first guide plates 16.

The frame 12 is formed in a box shape of a steel plate or the like. The frame 12 supports so that the tape feeding unit 14 and the tape cutting unit 15 perform a predetermined operation. In this example, the frame 12 also serves as a frame for the sticking reinforcing unit 66.

As illustrated in FIGS. 2 to 5, the tape feeding unit 14 includes a first shaft 18, a first gear 19, a first spur gear 20, a first pulley 22, a first belt 23, a second pulley 24, feeding rollers 25 and 26, a supply roller 28, and a wind-up roller 29. The first shaft 18 is supported by the frame 12 so as to be rotatable about an axis that extends in the left and right direction Y at a rear portion of the frame 12. A first handle 13 is fixed to the left end portion of the first shaft 18. The first handle 13 is rotatable about a rotation shaft that extends in the left and right direction Y.

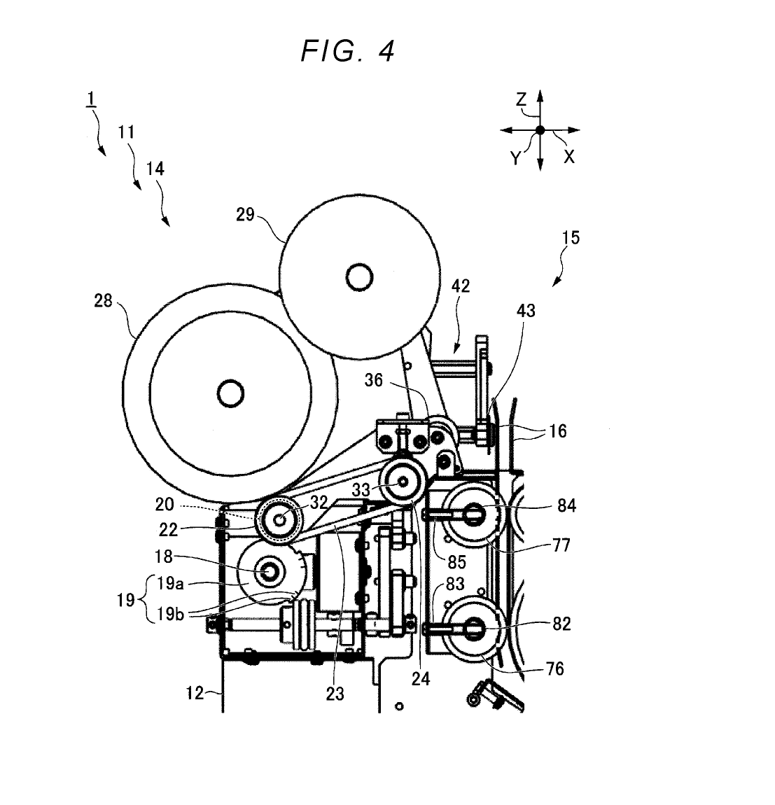

The first gear 19 is fixed to the left end portion of the first shaft 18. As illustrated in FIG. 4, the first gear 19 has a gear main body 19a and a plurality of teeth 19b. In FIG. 4, a plurality of teeth 19b are schematically illustrated.

The gear main body 19a is formed in a disc shape. The plurality of teeth 19b are partially arranged on outer circumferential surface of the gear main body 19a in the outer circumferential direction for a predetermined angular range with respect to the rotation axis of the first gear 19.

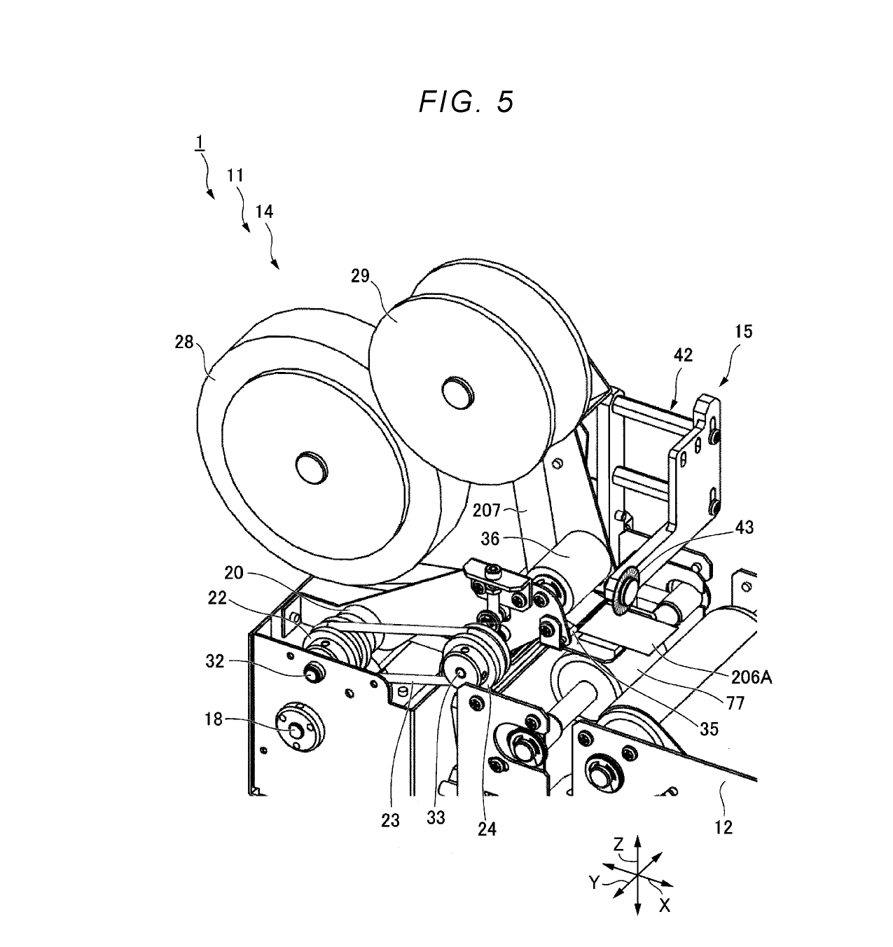

As illustrated in FIGS. 4 and 5, the second shaft 32 and the third shaft 33 are supported by the frame 12 so as to be rotatable about an axis that extends in the left and right direction Y. The second shaft 32 is disposed above the first shaft 18. The third shaft 33 is disposed on a front side of the second shaft 32.

The first spur gear 20 is fixed to the second shaft 32. The teeth of the first spur gear 20 can mesh with the teeth 19b of the first gear 19. When the teeth 19b of the first gear 19 mesh with the teeth of the first spur gear 20, if the first gear 19 is rotated, the first spur gear 20 rotates according to the rotation of the first gear 19. On the other hand, when the teeth 19b of the first gear 19 does not mesh with the teeth of the first spur gear 20, the first spur gear 20 does not rotate even if the first gear 19 is rotated.

As illustrated in FIG. 3, the first pulley 22 is fixed to the right side of the first spur gear 20 on the second shaft 32. A first belt 23 is wound around the first pulley 22.

As illustrated in FIGS. 4 and 5, the second pulley 24 is fixed to the third shaft 33. A first belt 23 is wound around the second pulley 24. When the first pulley 22 rotates, a force of rotating the first pulley 22 is transmitted to the second pulley 24 via the first belt 23, and the third shaft 33 rotates according to the rotation of the second pulley 24.

As illustrated in FIG. 2, the feeding rollers 25 and 26 are disposed so as to extend along the left and right direction Y. The feeding roller 26 is disposed above the feeding roller 25.

The feeding roller 25 is fixed to the third shaft 33. The feeding roller 26 is supported by the frame 12 so as to be rotatable about an axis that extends in the left and right direction Y. The feeding roller 26 is elastically biased downward by a spring (not illustrated).

The supply roller 28 and the wind-up roller 29 are supported by the frame 12 so as to be rotatable about an axis that extends in the left and right direction Y. The lower end portion of the supply roller 28 is disposed behind the feeding rollers 25 and 26. The supply roller 28 is wound with the adhesive tape 206A and the release paper 207 laminated thereto. The adhesive tape 206A is cut to a certain length to produce the adhesive tape 206. The release paper 207 covers the adhesive layer 206b of the adhesive tape 206A.

The wind-up roller 29 is disposed above the feeding rollers 25 and 26. A release paper 207 is wound around the wind-up roller 29.

As illustrated in FIGS. 2 and 5, a guide pin 35 and a guide roller 36 are disposed on a path along which the release paper 207 is transported. The guide pin 35 peels off the release paper 207 from the adhesive tape 206A. The guide roller 36 holds the release paper 207 in a stretched state on the path along which the release paper 207 is transported.

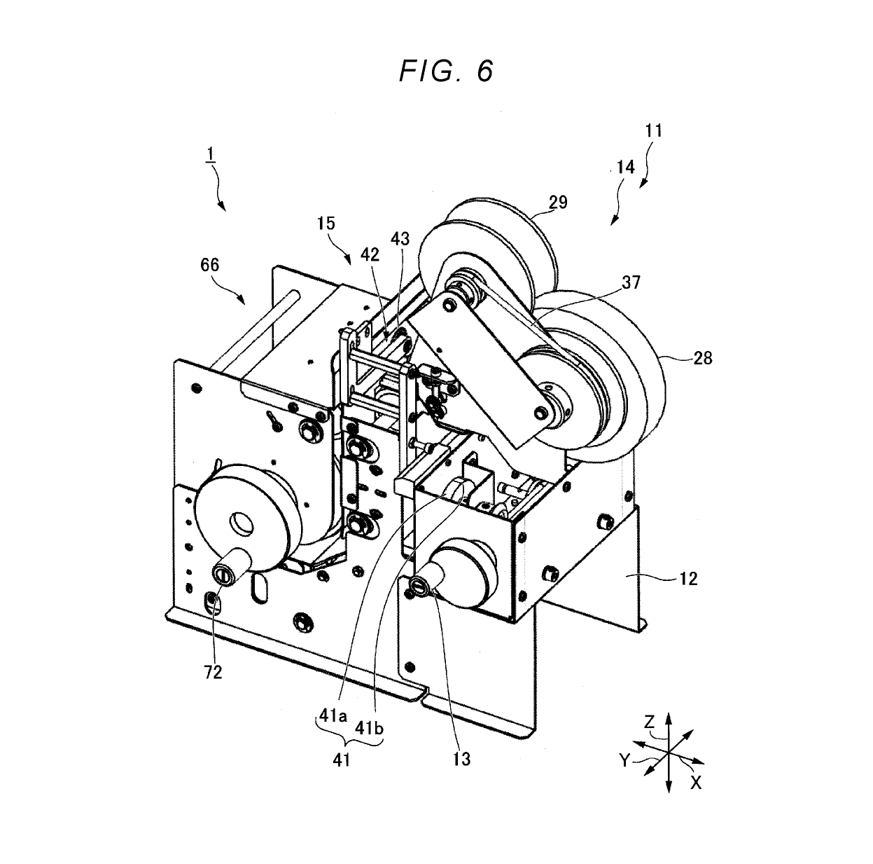

For example, the supply roller 28 rotates corresponding to the second shaft 32 by an interlocking mechanism (not illustrated). As illustrated in FIG. 6, a second belt 37 is wound around the supply roller 28 and the wind-up roller 29. Therefore, when the second shaft 32 rotates, the supply roller 28 and the wind-up roller 29 rotate.

The tape feeding unit 14 configured as described above operates as follows.

When the user rotates the first handle 13, during a period (hereinafter referred to as feeding period) in which the teeth 19b of the first gear 19 mesh with the teeth of the first spur gear 20, the feeding unit 14 operates as follows. The supply roller 28 rotates to feed the adhesive tape 206A and the release paper 207 forward. The feeding rollers 25 and 26 rotate to feed the adhesive tape 206A and the release paper 207 forward while pinching the adhesive tape 206A and the release paper 207 in the up and down direction Z. The guide pin 35 peels off the release paper 207 from the adhesive tape 206A. The wind-up roller 29 rotates to take up the release paper 207.

In this manner, the tape feeding unit 14 feeds the adhesive tape 206A forward by a predetermined length during the feeding period.

As illustrated in FIGS. 2 and 3, the tape cutting unit 15 includes a first bevel gear 39, a second bevel gear 40, a second gear 41, a link mechanism 42, a rotary cutter 43, and a tape base 44.

The first bevel gear 39 is coaxially fixed to the first shaft 18. The second bevel gear 40 is secured to the rear end portion of the fourth shaft 48. The fourth shaft 48 is supported by the frame 12 so as to be rotatable about an axis that extends in the front and rear direction X.

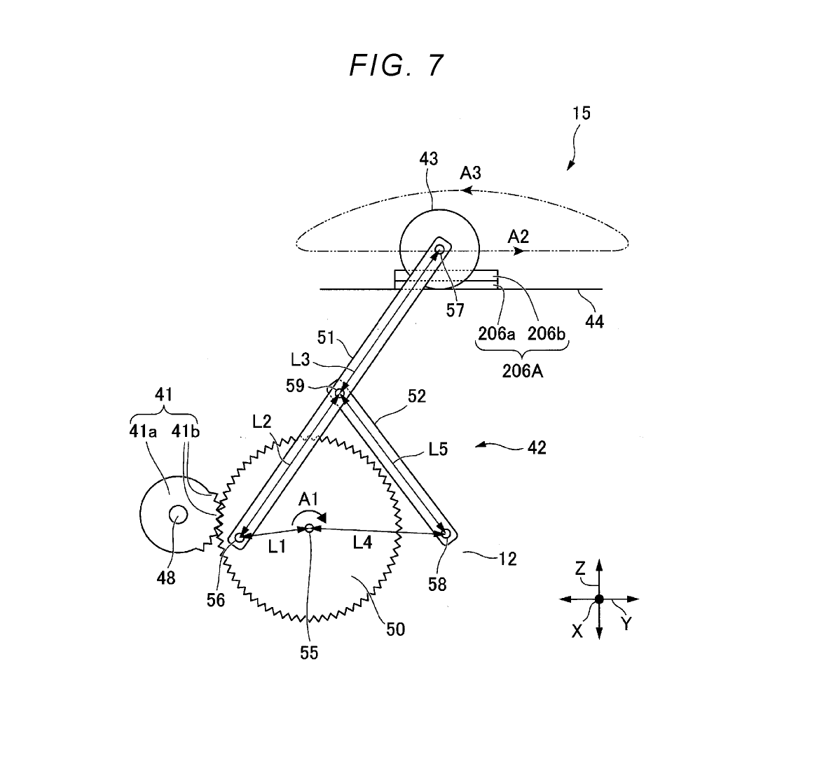

The second gear 41 is fixed to the front end portion of the fourth shaft 48. As illustrated in FIGS. 3 and 7, the second gear 41 is configured similarly to the first gear 19 and has a gear main body 41a and a plurality of teeth 41b which are partially arranged on outer circumferential surface of the gear main body 41a for a predetermined angular range with respect to a rotation axis of the second gear 41. The plurality of teeth 41b are provided on a range of a portion of the circumferential direction of the gear main body 41a on the outer circumferential surface of the gear main body 41a.

As illustrated in FIG. 7, the link mechanism 42 uses a known Chebyshev link mechanism. Hereinafter, an example in which the configuration of the link mechanism 42 is simplified will be described. For example, the link mechanism 42 includes a second spur gear 50, a first link member 51, and a second link member 52.

The second spur gear 50 is fixed to the fifth shaft 55. The fifth shaft 55 is supported by the frame 12 so as to be rotatable about an axis that extends in the front and rear direction X.

The teeth of the second spur gear 50 can mesh with the teeth 41b of the second gear 41. When the teeth 41b of the second gear 41 mesh with the teeth of the second spur gear 50, if the second gear 41 is rotated, the second spur gear 50 rotates according to the rotation of the second gear 41. On the other hand, when the teeth 41b of the second gear 41 does not mesh with the teeth of the second spur gear 50, even if the second gear 41 is rotated, the second spur gear 50 does not rotate.

The first link member 51 and the second link member 52 are formed in a rod shape.

The first end portion of the first link member 51 is rotatably connected to the outer edge portion of the second spur gear 50 by the first pin 56. A rotary cutter 43 is rotatably connected to the second end portion of the first link member 51 by a second pin 57.

The first end portion of the second link member 52 is rotatably connected to the frame 12 by the third pin 58. The second end portion of the second link member 52 is rotatably connected to the center portion of the first link member 51 in the longitudinal direction, by the fourth pin 59.

Here, the distance between the center of the fifth shaft 55 and the center of the first pin 56 is L1. The distance between the center of the first pin 56 and the center of the fourth pin 59 is L2. The distance between the center of the fourth pin 59 and the center of the second pin 57 is L3. The distance between the center of the fifth shaft 55 and the center of the third pin 58 is L4. The distance between the center of the third pin 58 and the center of the fourth pin 59 is L5. In the link mechanism 42 of this example, the distances L1 to L5 are set so as to satisfy the expression (1).

L1:L2:L3:L4:L5=1:2.5:2.5:2:2.5 (1)

As will be described below, the tape base 44 is disposed at a position where the rotary cutter 43 comes into contact with the lower end portion of the rotary cutter 43 when the rotary cutter 43 moves downward.

The tape cutting unit 15 configured as described above operates as follows.

When the user rotates the first handle 13, during a period (hereinafter referred to as a cutting period) in which the teeth 41b of the second gear 41 mesh with the teeth of the second spur gear 50, the tape cutting unit 15 operates as follows. The second spur gear 50 rotates in the direction A1 about the fifth shaft 55 according to the rotation of the second gear 41. In a state where the rotary cutter 43 moves along a lower moving path thereof, the rotary cutter moves in the direction A2 while being in contact with the tape table 44. At this time, the rotary cutter 43 cuts the adhesive tape 206A. Where the rotary cutter 43 cuts the adhesive tape 206A, the release paper 207 is peeled off from the adhesive tape 206A. The adhesive tape 206A is disposed so that the adhesive layer 206b is on the base material layer 206a.

When the first handle 13 is further rotated, in a state where the rotary cutter 43 is moved along an upper moving path thereof, rotary cutter moves in a direction A3 at a position separated from the tape base 44.

Since the Chebyshev link mechanism is used for the link mechanism 42, it is possible to return the rotary cutter 43 to an original position thereof in a state where the rotary cutter 43 is separated from the tape base 44 after the rotary cutter 43 comes into contact with the adhesive tape 206A on the tape base 44 and cuts the adhesive tape 206A.

The angular range of the plurality of teeth 19b of the first gear 19 and the range of the plurality of teeth 41b of the second gear 41 is determined so that the feeding period and cutting period described above are generated once without overlapping with each other while the first handle 13 rotates once. Therefore, when the first handle 13 makes one rotation, the adhesive tape 206A is fed forward by a fixed length in the feeding period. Then, the adhesive tape 206A having a fixed length is cut in the cutting period to produce the adhesive tape 206.

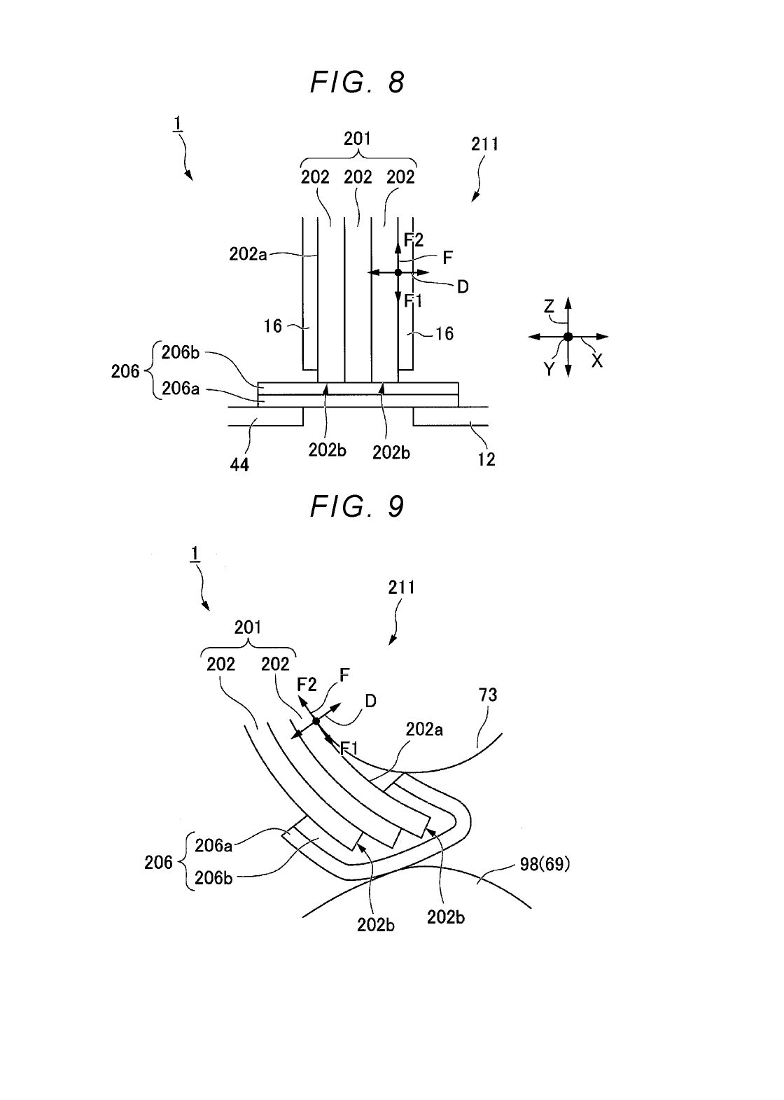

As illustrated in FIG. 2 and FIG. 3, the pair of first guide plates 16 is formed of a plate material having a thickness in the front and rear direction X. The pair of first guide plates 16 is disposed with a gap in the front and rear direction X. As illustrated in FIG. 8, the pair of first guide plates 16 is fixed to the frame 12 in a state where the lower end portion is disposed forward of and above the tape base 44.

As a result of the cutting of the adhesive tape 206, the adhesive tape 206 cut by the rotary cutter 43 is placed below the pair of first guide plates 16 as shown in FIG. 8. At this position, the adhesive tape 206 extends to the front of the front first guide plate 16 and the adhesive tape 206 extends to the rear of the rear first guide plate 16.

A paper bundle 201 between a pair of first guide plates 16 is supplied in a first direction F1 of the reference direction F, illustrated in FIGS. 1 and 8. The edge portion 202b of the plurality of sheets of paper 202 is the end portion of the paper bundle 201 in the first direction F1.

Then, the paper bundle connected body 211 is formed by applying the adhesive tape 206 to the edge portion 202b of the plurality of sheets of paper 202 in the paper bundle 201. At this time, the adhesive tape 206 is applied to the paper bundle 201 such that the adhesive layer 206b faces inward. In the sticking unit 11, the adhesive tape 206 is adhered to the edge portions 202b of the plurality of sheets of paper 202.

As illustrated in FIGS. 2 and 3, the sticking reinforcing unit 66 includes a moving unit 67, a bending unit 68, and a pressing unit 69.

The moving unit 67 has a second handle 72, a first driving roller 73, a second driving roller 74, a first belt 75, a first driven roller 76, and a second driven roller 77.

As illustrated in FIG. 2, the first shaft 80 and the second shaft 81 are supported by the frame 12 so as to be rotatable about an axis that extends in the left and right direction Y at an intermediate portion of the frame 12 in the front and rear direction X. The second shaft 81 is disposed on the rear side of the first shaft 80 and above the first shaft 80.

A first driving roller 73 is fixed to a center portion of the first shaft 80 in the left and right direction Y. A second handle 72 is fixed to the left end portion of the first shaft 80 (see FIG. 3). The second handle 72 is rotatable about a rotation shaft along the left and right direction Y.

A second driving roller 74 is fixed to a central portion of the second shaft 81 in the left and right direction Y. The diameter of the second driving roller 74 is smaller than the diameter of the first driving roller 73. The position of the rear end portion of the second driving roller 74 and the position of the rear end portion of the first driving roller 73 are equal to each other in the front and rear direction X.

A first belt 75 is wound around each of the first driving roller 73 and the second driving roller 74.

A third shaft 82 is disposed behind the first shaft 80. The third shaft 82 is supported by the support member 83 so as to be rotatable about an axis that extends in the left and right direction Y and is biased toward the first driving roller 73. The positions of the first shaft 80 and the third shaft 82 are equal to each other in the up and down direction Z.

The fourth shaft 84 is disposed on the rear side of the second shaft 81. The fourth shaft 84 is supported by the support member 85 so as to be rotatable about an axis that extends in the left and right direction Y and is biased toward the second driving roller 74. The positions of the second shaft 81 and the fourth shaft 84 are equal to each other in the up and down direction Z.

The support members 83 and 85 are fixed to the frame 12.

A first driven roller 76 is fixed to a central portion of the third shaft 82 in the left and right direction Y. A second driven roller 77 is fixed to a central portion of the fourth shaft 84 in the left and right direction Y. The diameter of the driven rollers 76 and 77 and the diameter of the second driving roller 74 are equal to each other.

The first driving roller 73 and the first driven roller 76 are in contact with or face each other in the front and rear direction X. The second driving roller 74 and the second driven roller 77 are in contact with or face each other in the front and rear direction X. The driven rollers 76 and 77 are movable backward against the biasing forces of the support members 83 and 85.

When the second handle 72 is rotated, the first driving roller 73 rotates via the first shaft 80. Further, the rotational force of the first driving roller 73 is transmitted to the second driving roller 74 via the first belt 75, and the second driving roller 74 rotates.

In this manner, each of the first driving roller 73 and the first driven roller 76, and the second driving roller 74 and the second driven roller 77 conveys the paper bundle connected body 211 in the reference direction F while pinching the paper bundle connected body 211 in the thickness direction D.

A nip N1 formed by the second driving roller 74 and the second driven roller 77 is disposed below a pair of first guide plates 16 of the sticking unit 11.

In the present embodiment, the second guide plate 89 is disposed below a nip N2 formed by the first driving roller 73 and the first driven roller 76. The second guide plate 89 and the first driving roller 73 make up a bending unit 68 that bends the edge portions 202b of the plurality of sheets of paper 202.

The second guide plate 89 has a first divided member 90 and a second divided member 91. The first divided member 90 is inclined gradually downward as it goes forward. At the front end portion of the first divided member 90, a protrusion portion 92 projecting obliquely rearward and downward is provided. The second divided member 91 extends forward from the front end portion of the first divided member 90. A cutout (not illustrated) penetrating the second divided member 91 in the up and down direction Z may be formed at the front end portion of the second divided member 91. The second divided member 91 is disposed below the first driving roller 73.

For example, the second guide plate 89 is rotatable about an axis that extends in the left and right direction Y by the protrusion portion 92 being supported by the frame 12. The second guide plate 89 is held in a position illustrated in FIG. 2 in a state where the second divided member 91 is biased upwardly by the spring 93 from below. The second guide plate 89 is held in the position of FIG. 2 by being in contact with a holding member (not illustrated) or the like.

When the second guide plate 89 is rotated about the protrusion portion 92 against the biasing force of the spring 93, the second guide plate 89 moves to the position indicated by the two-dot chain line in FIG. 2. In other words, the first divided member 90 moves downward, and the second divided member 91 moves upward by the rotation of the second guide plate 89 about the protrusion portion 92.

In an alternative embodiment, the second guide plate 89 may be fixed to the frame 12.

A cutout 12b is formed in the side plate 12a having a thickness in the left and right direction Y. So as to avoid interference with the paper bundle connected body 211, the cutout 12b is formed so as to correspond to the nips N1 and N2 and the gap between the second guide plate 89 and the first driving roller 73 in the left and right direction Y and is formed.

The cutout 12b extends to the bottom portion 12c which is on front side of a position corresponding to the lower end portion of the first driving roller 73 in the left and right direction Y.

When the leading end of the paper bundle connected body 211 comes into contact with the bottom portion 12c of the cutout 12b from the rear side, the paper bundle connected body 211 cannot move further forward (i.e., in first direction F1). The bottom portion 12c of the cutout 12b functions as a regulating unit that regulates the forward movement range of the paper bundle connected body 211.

A fifth shaft 96 is disposed below the first driving roller 73. The fifth shaft 96 is supported by the support member 97 so as to be rotatable about an axis that extends in the left and right direction Y and is biased upward. A support roller 98 is fixed to a central portion of the fifth shaft 96 in the left and right direction Y. The fifth shaft 96, the support member 97, and the support roller 98 make up a pressing unit 69 that presses the adhesive tape 206 against the edge portions 202b of the plurality of sheets of paper 202.

The support roller 98 may be movable upward of the second divided member 91 through a cutout formed in the second divided member 91 of the second guide plate 89.

Next, a paper binding method according to this embodiment will be described.

First, in the adhesive applying operation, the user rotates the first handle 13 one turn in a predetermined direction. Then, as illustrated in FIG. 8, the adhesive tape 206 is cut and disposed below the pair of first guide plates 16. At this time, the adhesive tape 206 is disposed so that the adhesive layer 206b faces upward. The paper bundle 201 in a state of being aligned between the pair of first guide plates 16 is supplied in the first direction F1. Then, the paper bundle 201 moves downward with respect to the adhesive tape 206 due to the weight of the paper bundle 201, and as illustrated in FIG. 1, the adhesive tape 206 is wrapped around the edge portion 202b of the plurality of sheets of paper 202. A paper bundle connected body 211 in which the adhesive tape 206 is adhered to the edge portion 202b of the plurality of sheets of paper 202 is formed.

The paper bundle connected body 211 falls toward the nip N1 of the second driving roller 74 and the second driven roller 77 due to own weight thereof.

Next, in the movement, bending, and pressing operation, the second handle 72 of the moving unit 67 is rotated in a predetermined direction. Accordingly, the paper bundle connected body 211 moves in the first direction F1 while the paper bundle connected body 211 is pinched in the thickness direction D with the second driving roller 74 and the second driven roller 77, and the first driving roller 73 and the first driven roller 76. Then, the bending unit 68 bends the edge portions 202b of the plurality of sheets of paper 202 on the planes parallel to the thickness direction D and the reference direction F, respectively.

The second driven roller 77 moves in the front and rear direction X according to the thickness of the paper bundle connected body 211 when pinching the paper bundle connected body 211 with the second driving roller 74 and the second driven roller 77. The first driven roller 76 is also similar to the second driven roller 77.

When the edge portions 202b of the plurality of sheets of paper 202 are bent, the edge portions 202b of the plurality of sheets of paper 202 comes into contact with a guide surface of the first divided members 90, 91 of the second guide plate 89. The paper bundle connected body 211 rotates the second guide plate 89 about the protrusion portion 92 against the biasing force of the spring 93. The paper bundle connected body 211 moves along the outer circumferential surface of the first driving roller 73 between the first driving roller 73 and the second guide plate 89. Since the second divided member 91 of the second guide plate 89 moves upward (i.e., to the position indicated by two-dot chain line in FIG. 2) so as to approach the lower end portion of the first driving roller 73, the edge portions 202b of the plurality of sheets of paper 202 can be reliably bent.

The downward movement amounts of each of the sheets of paper 202 forming the paper bundle connected body 211 by the moving unit 67, are equal to each other. On the other hand, among the plurality of bent sheets of paper 202, the inner paper 202 and the outer paper 202 have a different radius of curvatures from each other.

Therefore, as illustrated in FIG. 9, the positions of the edge portions 202b of each of the plurality of sheets of paper 202 are shifted from each other in the reference direction F along the main surface 202a. Specifically, the edge portion 202b of the inner paper 202 is placed at a position advanced to the first direction F1.

The adhesive tape 206 is stretched in the thickness direction D of the plurality of sheets of paper 202.

When the paper bundle connected body 211 comes into contact with the bottom portion 12c of the cutout 12b of the frame 12 and the paper bundle connected body 211 cannot move in the first direction F1 even if the second handle 72 is rotated, the rotation of the second handle 72 is stopped. Then, the support roller 98 of the pressing unit 69 presses the adhesive tape 206 upward toward the edge portions 202b of each of the plurality of sheets of paper 202 which are shifted from each other in the reference direction F. The adhesive layer 206b of the adhesive tape 206 enters between the edge portions 202b of the plurality of paper sheets of paper 202 adjacent to each other in the thickness direction D.

Next, in the returning operation, the second handle 72 is rotated in a direction opposite to the predetermined direction. Accordingly, while the paper bundle connected body 211 is pinched between the second driving roller 74 and the second driven roller 77, and the first driving roller 73 and the first driven roller 76 in the thickness direction D, the paper bundle connected body 211 is moved in the second direction F2 opposite to the first direction F1.

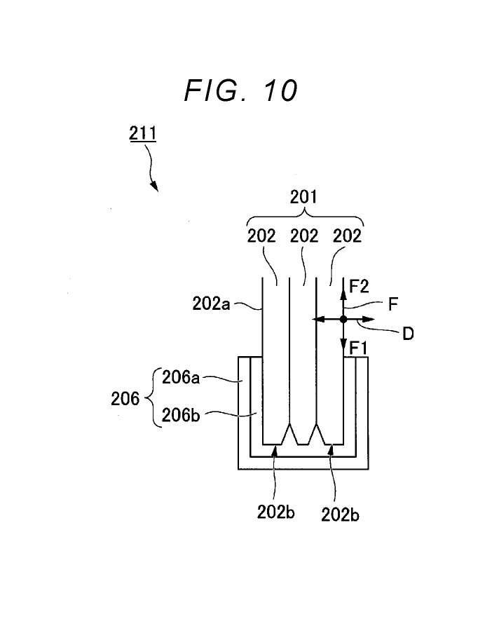

Then, since the edge portion 202b of the inner sheet 202 advances in the second direction F2, as illustrated in FIG. 10, the positions of the edge portions 202b of each of the plurality of sheets of paper 202 in the reference direction F are equal to each other and the paper bundle 201 is in an aligned state. The adhesive tape 206 shrinks in the thickness direction D in a state where the adhesive layer 206b of the adhesive tape 206 enters between the edge portions 202b of the plurality of paper sheets of paper 202. When the adhesive tape 206 returns to the original length, the edge portion 202b of the paper 202 shrinks in the thickness direction D. Therefore, the adhesive tape 206 is reliably sticked to the edge portions 202b of the plurality of sheets of paper 202.

The second guide plate 89 returns to the position illustrated in FIG. 2 by the biasing force of the spring 93.

Thus, the entire process of the paper binding method is completed, and the paper bundle connected body 211 in which the adhesive tape 206 is reliably adhered to the edge portion 202b of the plurality of sheets of paper 202 is formed.

According to the paper binding apparatus 1 and the paper binding method of this embodiment, the paper bundle connected body 211 is moved in the first direction F1 by the moving unit 67, the edge portions 202b of each of the plurality of sheets of paper 202 is shifted from each other in the reference direction F when the edge portions 202b of the plurality of sheets of paper 202 are bent by the bending unit 68. At this time, in a state where the adhesive tape 206 extended in the thickness direction D enters between the edge portions 202b of the plurality of sheets of paper 202, the adhesive tape 206 shrinks in the thickness direction D. When the adhesive tape 206 returns to the original length, the edge portion 202b of the paper 202 shrinks in the thickness direction D. Therefore, the adhesive tape 206 is reliably adhered to the edge portions 202b of the plurality of sheets of paper 202.

When the paper bundle connected body 211 is moved in the second direction F2 by the moving unit 67, the paper bundle 201 is aligned in a state where the adhesive tape 206 is sticked to the paper bundle 201. Since the paper bundle 201 is in an aligned state, the total length of the plurality of sheets of paper 202 in the reference direction F is maintained at the length of one sheet of the paper 202.

Therefore, it is possible to reliably apply the adhesive tape 206 to the plurality of sheets of paper 202 while suppressing an increase in the total length of the plurality of sheets of paper 202 in the reference direction F.

The paper binding apparatus 1 includes a pressing unit 69. Accordingly, the adhesive tape 206 can be applied more reliably to the edge portions 202b of the plurality of sheets of paper 202.

The paper binding apparatus 1 includes a sticking unit 11. Therefore, the paper binding apparatus 1 can automatically perform the adhesive applying step of applying the adhesive tape 206 to the edge portions 202b of the plurality of sheets of paper 202.

The paper binding apparatus 1 includes a bottom portion 12c of the cutout 12b. Therefore, excessive movement of the paper bundle connected body 211 in the first direction F1 in the paper binding apparatus 1 can be suppressed. Then, in a state where the paper bundle connected body 211 is in contact with the bottom portion 12c of the cutout 12b, so as to press the adhesive tape 206 with the pressing unit 69, the adhesive tape 206 is reliably pressed by the pressing unit 69.

In the present embodiment, the paper binding apparatus 1 may not be provided with the sticking unit 11 but may include only the sticking reinforcing unit 66. In this case, the user applies the adhesive tape 206 to the paper bundle 201 in an aligned state in advance to form the paper bundle connected body 211. Then, the paper bundle connected body 211 is inserted into the sticking reinforcing unit 66 and used.

The paper binding apparatus 1 may not have the pressing unit 69. The bottom portion 12c of the cutout 12b may not be formed in the frame 12.

Although the user manually rotates the handles 13 and 72 to rotate the first shafts 18 and 80, the first shafts 18 and 80 may be automatically rotated by a motor or the like.

According to at least some embodiment described above, by having the bending unit 68, it is possible to suppress an increase in the total length of the plurality of sheets of paper 202 in the reference direction F to reliably apply the adhesive tape 206 to the plurality of sheets of paper 202.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A paper binding apparatus comprising:
a pair of guides between which a paper bundle connected body that is formed by applying an adhesive tape to edge portions of a plurality of sheets that are overlapped in a thickness direction, is moved in a reference direction that is along a main surface of the plurality of sheets while pinching the paper bundle connected body in the thickness direction;
a guide plate positioned on one side of the paper bundle connected body and downstream of the pair of guides in a forward movement direction of the paper bundle connected body, the guide plate having at least one guide surface that causes the paper bundle connected body guided by the at least one guide surface to be bent; and
a driving roller configure to rotate in a first direction to move the paper bundle connected body in the forward movement direction and to cause a leading edge of the paper bundle connected body to be guided and bent by the at least one guide surface and the edge portions of the plurality of sheets to be shifted from each other in the reference direction.

2. The apparatus according to claim 1, wherein the guide plate has a first guide surface that is oblique with respect to surfaces of the pair of guides and a second guide surface that is substantially perpendicular to the surfaces of the pair of guides.

3. The apparatus according to claim 2, wherein the second guide surface faces the driving roller.

4. The apparatus according to claim 3, further comprising:
a pressing member positioned to face the driving roller with the second guide surface interposed therebetween,
wherein the pressing member is movable to press the leading edge of the paper bundle connected body against the driving roller after the leading edge of the paper bundle connected body is moved to a position between the driving roller and the pressing member.

5. The apparatus according to claim 1, further comprising:
a regulating surface against which the paper bundle connected body abuts so as to limit a movement range of the paper bundle connected body.

6. The apparatus according to claim 1, wherein the driving roller is rotatable in a second direction that is opposite to the first direction to cause the paper bundle connected body to be moved in a reverse movement direction.

7. The apparatus according to claim 1, further comprising:
a roll of adhesive tape; and
a cutter positioned to cut off a portion of the adhesive tape after the portion of the adhesive tape is placed below the edge portions of the plurality of sheets.

8. A paper binding method comprising:
applying an adhesive tape to edge portions of a plurality of sheets that are overlapped in a thickness direction to form a paper bundle connected body;
moving the paper bundle connected body in a reference direction that is along a main surface of the plurality of sheets while pinching the paper bundle connected body in the thickness direction;
guiding the paper bundle connected body as the paper bundle connected body is moved with a guide plate positioned on one side of the paper bundle connected body and downstream of the pair of guides in a forward movement direction of the paper bundle connected body, the guide plate having at least one guide surface that causes the paper bundle connected body guided by the at least one guide surface to be bent; and
further moving the paper bundle connected body in the forward movement direction to cause a leading edge of the paper bundle connected body to be guided and bent by the at least one guide surface and the edge portions of the plurality of sheets to be shifted from each other in the reference direction.

9. The method according to claim 8, wherein the guide plate has a first guide surface that is oblique with respect to surfaces of the pair of guides and a second guide surface that is substantially perpendicular to the surfaces of the pair of guides.

10. The method according to claim 9, wherein the second guide surface faces the driving roller.

11. The method according to claim 10, further comprising:
moving a pressing member that faces the driving roller with the second guide surface interposed therebetween, to press the leading edge of the paper bundle connected body against the driving roller after the leading edge of the paper bundle connected body is moved to a position between the driving roller and the pressing member.

12. The method according to claim 11, further comprising:
limiting a movement range of the paper bundle connected body with a regulating surface against which the paper bundle connected body abuts.

13. The method according to claim 11, further comprising:
moving the pressing member to release the leading edge of the paper bundle connected body; and
rotating the driving roller in a second direction that is opposite to the first direction to cause the paper bundle connected body to be moved in a reverse movement direction.

14. The method according to claim 8, further comprising:
feeding adhesive tape from a roll; and
cutting off a portion of the adhesive tape after the portion of the adhesive tape is placed below the edge portions of the plurality of sheets.
